(19) United States
(12) Patent Application Publication
(10) Pub. No.: US 2021/0287828 A1
(43) Pub. Date: Sep. 16, 2021

(54) CABLE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: A-NAN YANG, Huaian (CN); HAN-RUN XIE, Huaian (CN); LU-YU CHANG, New Taipei (TW)

(21) Appl. No.: 17/200,873

(22) Filed: Mar. 14, 2021

(30) Foreign Application Priority Data
Mar. 16, 2020 (CN) 202020328020.2

(51) Int. Cl. H01B 7/295; H01B 7/02; H01B 7/18

(52) U.S. Cl. CPC H01B 7/295; H01B 7/0216; H01B 7/22; H01B 7/0275; H01B 7/0283; H01B 7/1875

(57) ABSTRACT

A cable includes: a core wire; and an insulating outer layer covering the core wire; where in the core wire including an inner conductor, an inner insulating layer covering the inner conductor, and an outer insulating layer covering the inner insulating layer, the inner insulating layer being made of a material having dielectric constant and loss factor not higher than those of the material of the outer insulating layer, the outer insulating layer being made of a flame-retardant material.

### BACKGROUND OF THE INVENTION

### 1. Field of the Invention

The present invention relates generally to a cable, and more particularly to a cable with flame retardant properties and low cost.

### 2. Description of Related Arts

With the development and popularization of electronic technology products, signal cables are widely used in household appliances, instrumentation, automation equipment, data centers, servers, switches, cloud computing and 5G as a tool for signal transmission. In the process of use, it may be easy to burn due to short circuit or high local temperature. Therefore, cables are generally made of flame-retardant materials, but flame-retardant materials are generally expensive, which will increase the manufacturing cost of cables.

Therefore, it is necessary to provide an improved cable with flame retardant properties and cheap price.

### SUMMARY OF THE INVENTION

A main object of the present invention is to provide a cable, which has flame-retardant properties and is cheap.

To achieve the above-mentioned object, a cable comprises: a core wire; andan insulating outer layer covering the core wire; whereinthe core wire including an inner conductor, an inner insulating layer covering the inner conductor, and an outer insulating layer covering the inner insulating layer, the inner insulating layer being made of a material having dielectric constant and loss factor not higher than those of the material of the outer insulating layer,the outer insulating layer being made of a flame-retardant material.

Compared to the prior art, the present invention has the advantage that the dielectric constant and loss factor of the inner insulating layer material of the cable are not higher than the dielectric constant and loss factor of the outer insulating layer material, and the outer insulating layer is made of flame-retardant materials, makes the cable meet the electrical characteristics of signal transmission integrity requirements, while having flame-retardant characteristics and price advantages.

### BRIEF DESCRIPTION OF THE DRAWING

FIG. 1 is a cross-sectional view of the cable of the present invention; and

FIG. 2 is a side view of one core wire of the cable in FIG.1.

### DETAILED DESCRIPTION OF THE PREFERRED EMBODIMENT

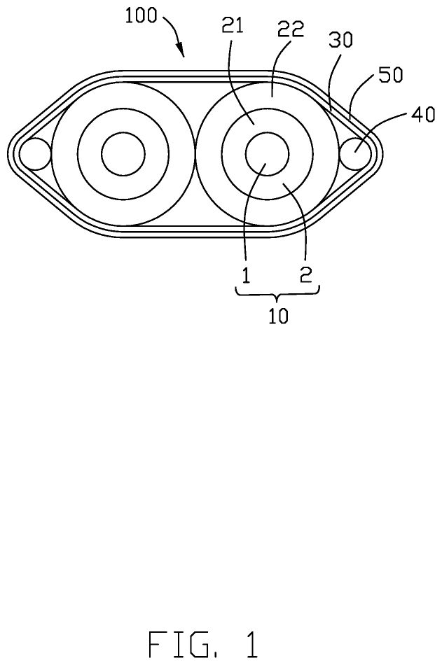

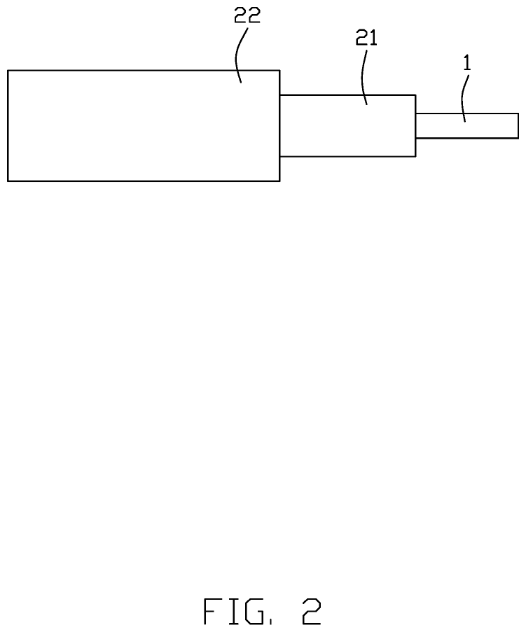

Referring to FIGS. 1-2, which is the cable 100 of the present invention.The cable 100 includes a pair of core wires 10, a shielding layer 30 covering the pair of core wire 10, an insulating outer layer 50 covering the shielding layer 30, and a ground wire 40 between the pair core wires 10 and the shielding layer 30.

In this embodiment, the pair of core wires 10 are contact with each other and extend in the longitudinal direction. Each of the core wire 10 includes an inner conductor 1 and an insulating layer 2 covering the inner conductor 1.The insulating layer 2 includes an inner insulating layer 21 covering the inner conductor 1 and an outer insulating layer 22 covering the inner insulating layer 21. The insulating layer 2 of each core wire 10 is extruded and molded to cover the inner conductor 1. The outer insulating layer 22 covers the inner insulating layer 21 by extrusion molding.Of course, the inner insulating layer 21 and the outer insulating layer 22 can also be wound,it can also be that one of the inner insulating layer 21 and the outer insulating layer 22 is formed by extrusion molding, and the other is wound.The inner insulating layer 21 is made of a material with low dielectric constant and low loss factor,the dielectric constant and loss factor of the material of the inner insulating layer 21 are not higher than the dielectric constant and loss factor of the material of the outer insulating layer 22.The outer insulating layer 22 is made of materials with flame-retardant properties.The outer insulating layer 22 uses materials with better flame retardant effects.The inner insulating layer 21 is made of material that is inexpensive and does not have flame-retardant properties.The inner insulating layer 21 is selected from the group including PP (polypropylene), PE (polyethylene), FEP (Fluorinated ethylene propylene), PTFE (polytetrafluoroethylene), foamed PP, foamed PE, foamed FEP, and PFA (Paraformaldehyde).The outer insulating layer 22 is selected from the group including FEP, PFA, PTFE, ETFE (Ethylene Tetra Fluor Ethylene), and TPE (thermoplastic elastomer). The shielding layer 30 covers the pair of core wires 10 in a longitudinal wrapping manner. The horizontal spiral wrapping method will have seams between adjacent windings, so the longitudinal wrapping has a better shielding effect. The shielding layer 30 is aluminum foil wrapping tape.The insulating outer layer 50 is a wrapping tape made of PET. The insulating outer layer 50 covers the shielding layer 30 in a spiral winding manner. The insulating outer layer 50 can be one layer or multiple layers,the adjacent layers of the insulating outer layer 50 are wrapped in different directions, which can offset the stress from each other, thereby making the structure of the cable more stable.

For the cable of the present invention, the inner insulating layer 21 of the insulating layer 2 is made of inexpensive and non-flame retardant materials, and the outer insulating layer 22 is made of materials with better flame retardant effects, makes the cable meet the electrical characteristics of signal transmission integrity requirements, while having flame-retardant characteristics and having the advantage of low price. The fire resistance rating of the cable can reach VW-I.

The above is only one of the embodiments of the present invention, but not all of the embodiments. Any equivalent changes to the technical solutions of the present invention by those skilled in the art by reading the description of the present invention are covered by the claims of the present invention.

What is claimed is:

1. A cable comprising:
a core wire; and
an insulating outer layer covering the core wire; wherein the core wire including an inner conductor, an inner insulating layer covering the inner conductor, and an outer insulating layer covering the inner insulating layer, the inner insulating layer being made of a material having dielectric constant and loss factor not higher than those of the material of the outer insulating layer,the outer insulating layer being made of a flame-retardant material.

2. The cable as claimed in claim 1, wherein the inner insulating layer is selected from the group consisting of PP, PE, FEP, FEA, foamed PP, foamed PE, foamed FEP, and foamed FEA .

3. The cable as claimed in claim 2, wherein the outer insulating layer is selected from the group consisting of FEP, PFA, PTFE, ETFE, and TPE.

4. The cable as claimed in claim 3, wherein the fire resistance rating of the cable reaches VW-I.

5. The cable as claimed in claim 1, whereinthe inner insulating layer and the outer insulating layer are both formed by extrusion molding.

6. The cable as claimed in claim 1, whereinone of the inner insulating layer and the outer insulating layer is formed by extrusion molding and the other is formed by winding.

7. The cable as claimed in claim 1, wherein there are a pair of wires arranged in parallel.

8. The cable as claimed in claim7, further comprising a shielding layer covering the pair of core wires.

9. The cable as claimed in claim 8, wherein the shielding layer is aluminum foil tape.

10. The cable as claimed in claim 9, wherein further comprising a ground wire arranged between the pair of core wires and the shielding layer.
